(19) United States
(12) Patent Application Publication
(10) Pub. No.: US 2025/0375903 A1
(43) Pub. Date: Dec. 11, 2025

(54) LONGITUDINALLY DEPLOYABLE VACUUM SUCTION CUP

(71) Applicant: SEOUL NATIONAL UNIVERSITY R&DB FOUNDATION, Seoul (KR)

(72) Inventors: Kyu Jin CHO, Seoul (KR); Jae Min EOM, Seoul (KR); Yun A YOO, Seongnam-si (KR); Min Jo PARK, Seoul (KR)

(73) Assignee: SEOUL NATIONAL UNIVERSITY R&DB FOUNDATION, Seoul (KR)

(21) Appl. No.: 19/221,448

(22) Filed: May 28, 2025

Related U.S. Application Data
(63) Continuation of application No. PCT/KR2023/019352, filed on Nov. 28, 2023.

(30) Foreign Application Priority Data
Nov. 29, 2022 (KR) 10-2022-0163123
Sep. 15, 2023 (KR) 10-2023-0122951

(51) Int. Cl. B25J 15/06; B25J 18/02; B25J 18/06

(52) U.S. Cl. CPC B25J 15/0625; B25J 15/065; B25J 18/025; B25J 18/06

(57) ABSTRACT

Disclosed in the present invention is a longitudinally deployable vacuum suction cup. A longitudinally deployable vacuum suction cup, according to one embodiment of the present invention, comprises: a vacuum pump that generates a vacuum; a plurality of air hoses connected to the vacuum pump through which air moves; a gripper body having one end connected to the plurality of air hoses so as to be deployed; an internal air hose located inside the gripper body through which air moves; an outer spring located between the gripper body and the internal air hose; a suction cup coupled to the other end of the gripper body and connected to the internal air hose to grip an object; and a three-way valve connecting the internal air hose and the vacuum pump.

### CROSS-REFERENCE TO RELATED APPLICATIONS

This application is a continuation of International Application No. PCT/KR2023/019352 filed on Nov. 28, 2023, which claims priority to Korean Patent Application No. 10-2022-0163123 filed on Nov. 29, 2022 and Korean Patent Application No. 10-2023-0122951 filed on Sep. 15, 2023, the entire contents of which are herein incorporated by reference.

### TECHNICAL FIELD

The present invention relates to a longitudinally deployable vacuum suction cup, and more specifically, to a longitudinally deployable vacuum suction cup in which a soft body extends in the longitudinal direction, and when it contacts an object, the body automatically contracts while gripping the object.

In conventional suction cups, it is necessary to accurately measure the relative distance and the tilted angle of the object with respect to the suction cup in order to grip the object. However, implementing this using only vision sensing technology and algorithms has the disadvantage of high sensing and control costs. In contrast, the longitudinally deployable vacuum suction cup of the present invention allows the extension and contraction of the body, as well as the suction gripping, to occur without the need for separate sensing and control. Therefore, it is possible to easily grip the object without the need to precisely measure the object's distance or tilt angle, thus reducing the sensing and control costs required for gripping.

### BACKGROUND ART

Suction cups are widely used in industrial settings because they can be easily and quickly operated. However, as industrial environments expand beyond traditional, standardized settings to unstructured environments such as logistics processes and bin picking, the need for suction cups to be used in these unstructured environments is increasing. In unstructured environments, errors in object position and angle sensing can occur, sometimes reaching several tens of centimeters, depending on the type of object (mostly transparent or highly reflective objects) or the background environment. Furthermore, using only vision sensing to accurately detect and grasp objects leads to high sensing and control costs.

FIGS. 1 and 2 are schematic diagrams showing conventional suction cups.

Referring to FIGS. 1 and 2 together, a suction cup has been developed that utilizes the longitudinal compliance of the cup body to reduce the cost of accurately determining the position of an object, allowing it to grip objects without the need for precise sensing and control. The conventional cup (1) utilizes a vacuum cylinder that moves the suction cup in the longitudinal direction, and when the cup contacts an object, it grips the object and returns to its original position. However, the body (2) of the vacuum cylinder is made of a rigid material, which has the disadvantage of being unable to grip tilted objects, unlike the present invention. The bellows suction cup (3) shown in FIG. 2 has a soft bellows-shaped body that adapts to press against a tilted object with a spaced distance, allowing it to grip the object. However, since it can only grip objects that are within a certain distance from the initial length of the body, the range and angle of objects that can be gripped are limited by the initial length of the body. Additionally, there are limitations to increasing the length of the body due to the risk of collision with surrounding objects and the limitations of the environment.

In unstructured environments, errors in object position and angle sensing can occur, reaching up to several tens of centimeters, depending on the type of object or the background environment. There is a problem in accurately detecting and grasping objects using only vision sensing.

Therefore, the longitudinally deployable vacuum suction cup presented in the present invention is a technology that can grip objects that are far from or tilted relative to the gripper without the need for separate sensing and control, and it is preferable for use in unstructured environments.

The research team has conducted studies on pneumatic actuators and grippers by performing demonstrations such as bin picking of transparent objects, depalletization in logistics processes, and grasping objects from shelves in logistics operations. They have conducted research on the design of pneumatic actuator connections, pneumatic circuit design, and new gripping methods.

### DISCLOSURE

### Technical Problem

An embodiment of the present invention provides a longitudinally deployable vacuum suction cup designed to easily grip an object even when there are errors in the sensing of the distance and angle between the object and the gripper. This is achieved through a gripper body design that contracts and extends in the longitudinal direction, and a pneumatic circuit design that allows the gripper to automatically contract and grip the object upon contact, without the need for additional sensing and control, in order to overcome the problems of the conventional technology.

### Technical Solution

According to an aspect of the present invention, the apparatus comprises: a vacuum pump that generates a vacuum; a plurality of air hoses connected to the vacuum pump through which air is transported; a gripper body that is deployable and connected at one end to the plurality of air hoses; an internal air hose located inside the gripper body through which air flows; an outer spring located between the gripper body and the internal air hose; a suction cup coupled to the other end of the gripper body and connected to the internal air hose for gripping an object; and a three-way valve connecting the internal air hose and the vacuum pump.

The vacuum pump is activated, and the gripper body is deployed such that the suction cup grips the object.

The plurality of air hoses are respectively connected to the gripper body.

One of the plurality of air hoses is provided with a three-way valve through which air moves to the external atmosphere.

The material of the gripper body is a polymer compound.

The polymer compound is made of a transparent LDPE film.

The polymer compound is made of a transparent thermoplastic polyurethane (TPU) elastomer.

The material of the gripper body has bendable flexibility.

The material of the gripper body is made of fabric.

The material of the gripper body is made of a flexible polymer.

The internal air hose contains an internal spring.

The internal air hose has a cylindrical shape.

The internal air hose has a coil shape.

The internal spring and the external spring are coil-shaped springs, each having elasticity.

It further includes a pump connection part that connects the gripper body and the plurality of air hoses.

It further includes a suction cup connection part that connects the gripper body and the suction cup.

According to another aspect of the present invention, it includes: a vacuum pump that generates a vacuum; a plurality of air hoses connected to the vacuum pump through which air is transported; a plurality of gripper bodies, each of which is connected at one end to the plurality of air hoses and is deployable; an internal air hose located inside each gripper body through which air flows; an outer spring located between each gripper body and the internal air hose; a suction cup coupled to the other end of each gripper body and connected to the internal air hose for gripping an object; and a three-way valve connecting the internal air hose and the vacuum pump.

According to another aspect of the present invention, a control method for a lengthwise deployable vacuum suction cup includes the steps of: activating a vacuum pump to apply negative pressure, thereby creating a vacuum inside the gripper body; reducing the length of the gripper body due to the negative pressure from the vacuum pump; releasing the vacuum state by connecting the air hoses to the external environment; deploying the length of the gripper body by the spring; gripping an object with a suction cup coupled to the end of the gripper body; and reducing the length of the gripper body after the suction cup has gripped the object due to the negative pressure of the vacuum pump.

In the step where the gripper body is connected to the outside through the suction cup, and the vacuum state is released, the air hoses are equipped with a three-way valve. When the three-way valve is switched, the vacuum pump continues to operate, and the negative pressure of the gripper body is released through the suction cup, which is connected to the air hose and the gripper body, allowing the vacuum state to be released to the outside.

In the step where the length of the gripper body decreases due to the negative pressure of the vacuum pump and the object is grasped by the suction cup, the internal space of the gripper body is vacuumized due to the sealing between the suction cup and the object.

The control method further includes the step of releasing the object by having the suction cup connect to the outside through the switching of the three-way valve after the transfer of the object held by the suction cup, with the gripper body maintaining its contraction while the object is released.

### Advantageous Effects

The longitudinally deployable vacuum suction cup according to the present invention has the following effects.

First, it can grip various objects regardless of their distance or position.

Second, it can grip moving objects.

Third, its simple structure allows for cost reduction.

Fourth, it can be used even in dynamic situations where the environment is unstructured or the positions of the object and the gripper are continuously changing relative to each other, thereby improving applicability.

Fifth, in unstructured environments where vision sensing errors frequently occur, it is possible to effectively reduce the sensing and control costs required for gripping the suction cup without needing to precisely determine the object's position through vision sensing. This is particularly effective for logistics or bin picking processes where objects vary in shape and arrangement.

Sixth, according to the present invention, the gripper body can be contracted when not in use, reducing the risk of collision with the surrounding environment, and it has the advantage of being extendable up to 2.4 times its original length.

### DESCRIPTION OF DRAWINGS

FIGS. 1 and 2 are schematic diagrams illustrating conventional suction cups.

FIG. 3(a) is a schematic diagram illustrating the gripper structure design for object gripping of the longitudinally deployable vacuum suction cup according to one embodiment of the present invention, and FIG. 3(b) is a schematic diagram illustrating the picking preparation stage, picking stage, and arrangement stage in the pneumatic circuit design for object gripping of the longitudinally deployable vacuum suction cup according to one embodiment of the present invention.

FIG. 4 is a diagram illustrating the case where the internal air hose has a coiled shape.

FIG. 5 is a diagram illustrating the state during the process of contraction of the longitudinally deployable vacuum suction cup according to one embodiment of the present invention.

FIG. 6 is a diagram sequentially illustrating an example of gripping an object at a distance using the longitudinally deployable vacuum suction cup according to one embodiment of the present invention.

FIG. 7 is a schematic diagram illustrating examples of gripping objects with different tilt angles according to one embodiment of the present invention.

FIG. 8 is a diagram sequentially illustrating an example of gripping and moving objects at different heights from the same position using the longitudinally deployable vacuum suction cup according to one embodiment of the present invention.

FIG. 9 is a diagram illustrating an example of reliably performing bin picking of transparent objects, where vision sensing errors frequently occur.

FIG. 10 is a diagram illustrating an example of using the device to retrieve objects from a narrow shelf where a robotic arm cannot reach in a logistics process.

FIG. 11 is a diagram sequentially illustrating an example of gripping a moving object using the longitudinally deployable vacuum suction cup according to one embodiment of the present invention.

FIG. 12 is a diagram illustrating an example of moving objects with different heights at once using the longitudinally deployable vacuum suction cup according to another embodiment of the present invention.

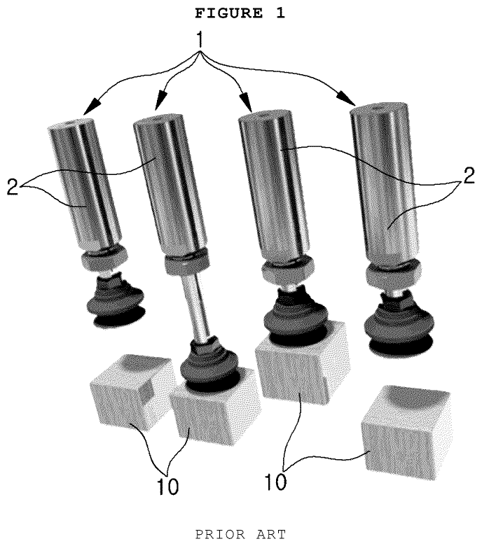

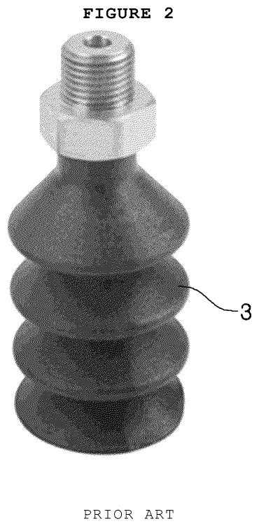

### BEST MODE

The following embodiments are provided to help those skilled in the art easily understand the technical spirit of the present invention, and the invention is not limited by these embodiments. Additionally, the elements depicted in the accompanying drawings are schematic representations intended to illustrate the embodiments of the present invention and may differ from the actual implementation.

When it is mentioned that one component is connected or coupled to another component, it should be understood that the connection or coupling may be direct, but there could also be other components in between.

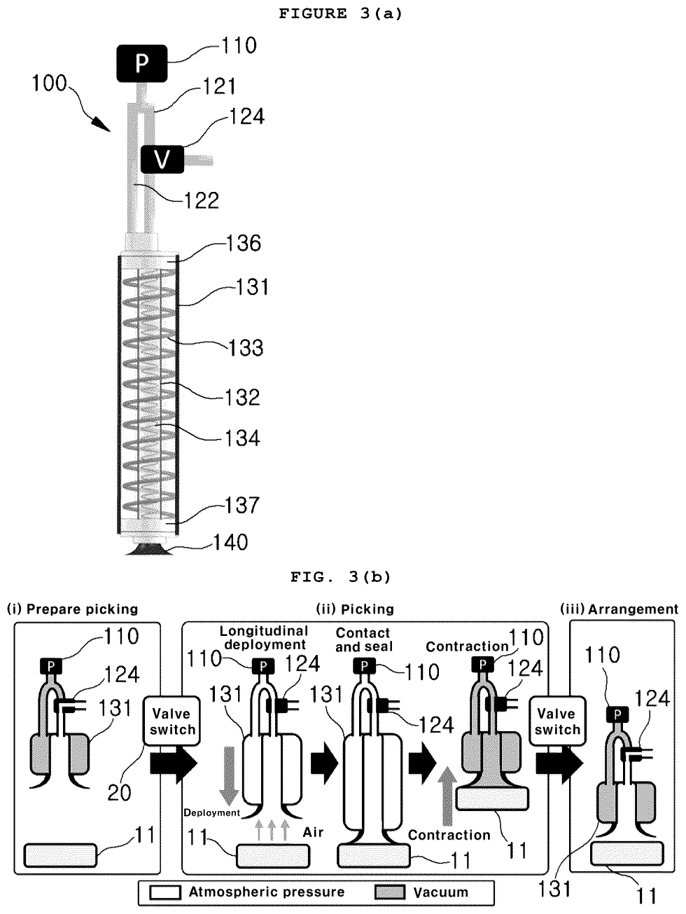

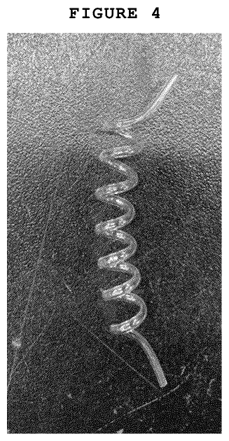

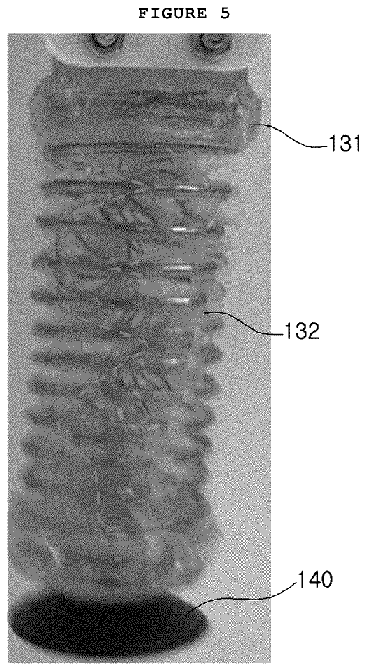

FIG. 3(a) is a schematic diagram illustrating the gripper structure design for object gripping of the longitudinally deployable vacuum suction cup according to one embodiment of the present invention. FIG. 3(b) is a schematic diagram illustrating the picking preparation stage, picking stage, and arrangement stage in the pneumatic circuit design for object gripping of the longitudinally deployable vacuum suction cup according to one embodiment of the present invention. FIG. 4 is a diagram illustrating the case where the internal air hose has a coiled shape, and FIG. 5 is a diagram illustrating the state during the process of contraction of the longitudinally deployable vacuum suction cup according to one embodiment of the present invention.

With reference to FIGS. 3 to 5, the longitudinally deployable vacuum suction cup (100) according to one embodiment of the present invention can function as a longitudinally deployable vacuum suction robotic arm, and is configured to include a vacuum pump (110), multiple air hoses (121, 122), a gripper body (131), an internal air hose (132), an outer spring (133), and a suction cup (140).

The vacuum pump (110) is connected to the outside and generates a vacuum.

The multiple air hoses (121, 122) are connected to the vacuum pump (110) and allow air to flow through them respectively.

The multiple air hoses (121, 122) are each connected to the gripper body (131).

The air hose (121) is connected to the internal air hose (132) within the gripper body (131).

The air hose (121) is equipped with a conventional three-way valve (124) through which air can flow to the external atmosphere.

The three-way valve (124) is configured to form an air passage to the suction cup (140), which is coupled to the air hose (121) and the internal air hose (132), or to form an air passage to the suction cup (140) connected to the internal air hose (132) through the external atmosphere via the three-way valve (124). This three-way valve (124) can switch the air passage by a valve switch that controls the direction of the air flow. The gripper body (131) is structured such that its internal space is divided by the internal air hose (132), and the air passage can be switched by the three-way valve (124).

The gripper body (131) is connected at one end to the multiple air hoses (121, 122) and has an extendable structure with a length that can be adjusted.

The gripper body (131) has an external hollow tubular shape, and inside it, the internal air hose (132) and the outer spring (133) are provided.

According to the present invention, the material of the gripper body (131) is preferably a polymer compound.

For example, the polymer compound may be made of transparent thermoplastic polyurethane (TPU) elastomer.

Alternatively, the polymer compound is preferably made of LDPE (Low Density Polyethylene) film.

Here, LDPE is produced by polymerizing ethylene monomers, and depending on the manufacturing method, it can be categorized into high-pressure polyethylene and low-to-medium pressure polyethylene. LDPE is manufactured under high pressure and high temperature. After adding a small amount of oxygen or peroxide to purified ethylene gas, it is heated at a high pressure of 2,000 atmospheres and at a temperature of approximately 200° C., resulting in the production of LDPE (Low Density Polyethylene) with a density of 0.915 to 0.925.

LDPE has a low density, which gives it excellent moldability, processability, and flexibility, as well as sealing and transparency properties. It is commonly used in films, vinyl, coatings, wires, cables, and foams.

Alternatively, the polymer compound may be made of a flexible polymer. Such a polymer compound is preferably made of a material with bending flexibility and is not limited to any specific type.

Alternatively, the material of the gripper body (131) may be made of a fabric, such as cloth.

The gripper body (131) is preferably a transparent hollow cylindrical structure that is exposed on the outside and has a hollow interior.

The internal air hose (132) may have a cylindrical shape with a coiled internal spring (134) embedded inside.

Alternatively, as shown in FIG. 4, the internal air hose (132) may take a coiled shape through heat treatment, such as quenching.

The internal air hose (132) is located inside the gripper body (131), with an internal spring (134) embedded inside, allowing air to flow through it.

The outer spring (133) is coil-shaped and positioned between the gripper body (131) and the internal air hose (132), enabling the deployment of the gripper body (131).

The suction cup (140) is coupled to the other end of the gripper body (131) and is used to grip objects. The suction cup (140) may, for example, be a suction cup.

With the structure described above, when the vacuum pump (110) is operating, the gripper body (131) is deployed, and the suction cup (140) grips the object. In the present invention, the gripping of the object refers to the suction cup (140) being vacuum-adsorbed onto the object as a result of the vacuum pump (110) operating, generating negative pressure that is applied to the suction cup (140) through the air hoses (121) and internal air hose (132).

Additionally, the longitudinally deployable vacuum suction cup (100) according to one embodiment of the present invention is further configured to include a pump connector (136) that connects the gripper body (131) to the multiple air hoses (121, 122).

The pump connector (136) connects the gripper body (131) to the multiple air hoses (121, 122) that are connected to the vacuum pump (110).

Furthermore, the longitudinally deployable vacuum suction cup (100) according to one embodiment of the present invention is further configured to include a suction cup connection part (137) that connects the gripper body (131) to the suction cup (140).

In addition, the longitudinally deployable vacuum suction cup (100) according to one embodiment of the present invention may further include a connection protective cover that protects the multiple air hoses (121, 122) from external impacts and connects them to the gripper body (131).

The pneumatic circuit design for object gripping in the longitudinally deployable vacuum suction cup (100) according to one embodiment of the present invention includes the picking preparation stage, picking stage, and arrangement stage, using the three-way valve (124). In the picking preparation stage, the vacuum pump (110) operates, generating negative pressure that creates a vacuum state inside the gripper body (131). As a result, the gripper body (131) shortens due to the negative pressure of the vacuum pump (110), and the suction cup (140) is connected to the outside through the internal air hose (132) and the three-way valve (124).

In the picking stage, first, the three-way valve (124) switches the air passage under the control of the valve switch (20), causing the vacuum pump (110) and the sealed gripper body (131) to be connected to the outside through the internal air hose (132) and the suction cup (140), thereby releasing the vacuum state inside the gripper body (131).

When the vacuum is released, the length of the gripper body (131) extends due to the springs. These springs include the outer spring (133), which is positioned between the gripper body (131) and the internal air hose (132), and the inner spring (134), which is located inside the internal air hose (132). In other words, the length of the gripper body (131) is extended by the elasticity of both the outer spring (133) and the inner spring (134) when the vacuum is released.

Subsequently, as the gripper body (131) extends downward, it makes contact and seals with the object (11) located beneath the suction cup (140), gripping and vacuum-adsorbing the object.

After the object (11) is gripped (vacuum-adsorbed), the length of the gripper body (131) is reduced as the negative pressure generated by the continuously operating vacuum pump (110) causes the object (11) to remain gripped by the suction cup (140).

After the gripped object (11) is transported to the transfer position, the suction cup (140) is disconnected from the object through valve switching, allowing it to be released by connecting the internal air hose (132) to the atmosphere. During this process, the gripper body (131) maintains the vacuum, thereby keeping its contracted state.

After the object arrangement stage, the process returns to the initial picking preparation stage, preparing for the next object (11) picking.

FIG. 5 is a diagram showing the state during the process of contraction of the longitudinally deployable vacuum suction cup according to one embodiment of the present invention.

Referring to FIG. 5 along with FIGS. 3 and 4, in one embodiment of the present invention, the diameter ratio between the internal air hose (132) and the gripper body (131) of the longitudinally deployable vacuum suction cup (100) is preferably 1:3. When the gripper body (131) contracts, if the diameter ratio between the internal air hose (132) and the gripper body (131) is smaller than 1:3, deformation inside the gripper body (131) does not occur easily, and the contraction of the gripper body (131) will not proceed smoothly. Additionally, as air moves through the internal air hose (132), a drop in atmospheric pressure occurs. If the pressure drop is severe, it will affect the deployment of the body. Since the pressure drop increases as the diameter of the internal air hose (132) decreases, a diameter ratio larger than 1:3 between the internal air hose (132) and the gripper body (131) will result in a larger pressure drop, which is undesirable.

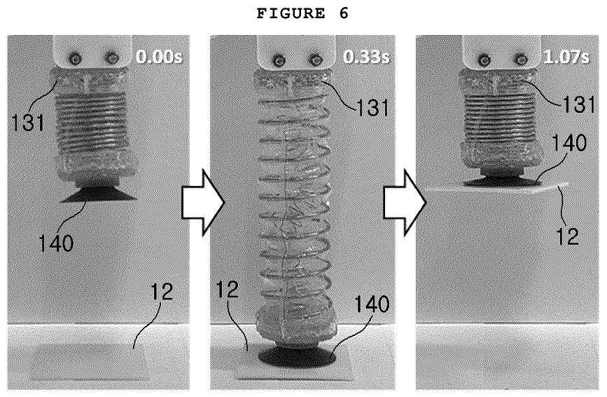

FIG. 6 is a diagram sequentially illustrating an example of gripping a distant object using the longitudinally deployable vacuum suction cup according to one embodiment of the present invention.

Referring to FIG. 6 along with FIG. 3, as explained earlier, the process of gripping a thin, flat object (12) is sequentially illustrated in the order of the arrows in FIG. 6.

That is, when the gripper body (131) deploys downward, it makes contact and forms a seal with the object (12) located beneath the suction cup (140), allowing the suction cup (140) to grip the object.

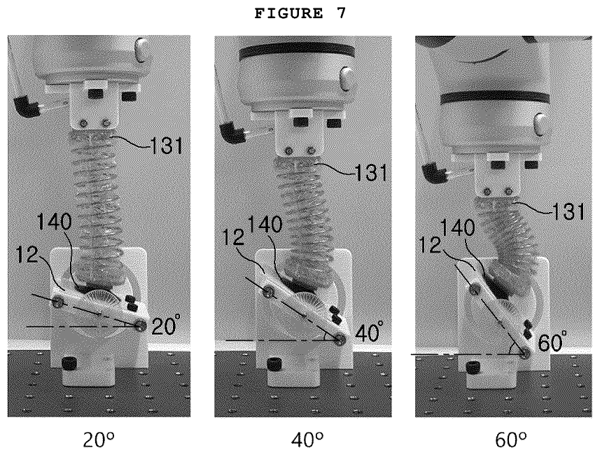

FIG. 7 is a schematic diagram illustrating examples of gripping objects tilted at different angles according to one embodiment of the present invention.

In FIG. 7, the object (12) is tilted at a 20° angle relative to the ground.

As explained earlier, the gripper body (131) deploys downward, and the suction cup (140) makes contact and forms a seal with the object (12) tilted at a 20° angle relative to the ground, thereby successfully performing the gripping operation.

In FIG. 7, the object (12) is tilted at a 40° angle relative to the ground. As the gripper body (131) deploys downward, the flexibility of the gripper body (131) allows the suction cup (140) to make contact and form a seal with the object (12), which is tilted at 40° relative to the ground, either on one side or the opposite side, successfully performing the gripping operation.

In FIG. 7, the object (12) is tilted at a 60° angle relative to the ground. As the gripper body (131) deploys downward, the flexibility of the gripper body (131) allows the suction cup (140) to make contact and form a seal with the object (12), which is tilted at 60° relative to the ground, either on one side or the opposite side, successfully performing the gripping operation.

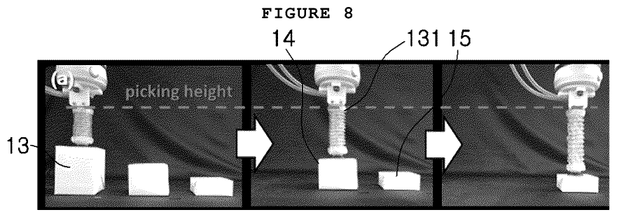

FIG. 8 illustrates an example in which the lengthwise deployable vacuum suction cup of the present invention is used to grasp and move objects of different heights from the same location sequentially.

Referring to FIG. 8 together with FIG. 3, as shown in the sequence indicated by the arrows, the lengthwise deployable vacuum suction cup (100) according to one embodiment of the 5 present invention allows the suction cup (140) to make contact and seal with objects (13, 14, 15) of different thicknesses, thereby performing a normal gripping action. This demonstrates that objects of different thicknesses can be sequentially transported.

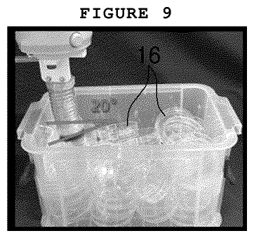

FIG. 9 illustrates an example where bin picking of transparent objects, which frequently causes vision sensing errors, is stably performed.

Referring to FIG. 9 in conjunction with FIG. 3, FIG. 9 shows a plurality of transparent objects (16) stored in a container in an unaligned state, with each object having a different angle relative to the ground.

Although a plurality of transparent objects (16) have different angles with respect to the ground, the longitudinally deployable vacuum suction cup (100), according to one embodiment of the present invention, enables the suction cup (140) to contact and seal with each of the transparent objects (16) inclined at different angles, thereby allowing normal gripping and sequential transfer.

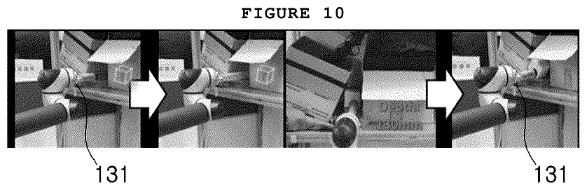

FIG. 10 is a diagram illustrating an example in which the device is used to retrieve an object located inside a narrow shelf where a robotic arm cannot reach in a logistics process.

Referring to FIG. 10 in conjunction with FIG. 3, in one embodiment of the present invention, the longitudinally deployable vacuum suction cup (100) includes a suction cup (140) coupled to the front end of the gripper body (131), which is deployed forward. That is, when the vacuum state is released, the suction cup (140), which is connected to the front end of the gripper body (131), is deployed into a narrow space where a robotic arm cannot enter, allowing the object to be gripped. Then, when the vacuum state is re-established, the gripper body (131) contracts, thereby enabling the transfer of the object.

At this time, the deployment length (depth) of the gripper body (131) toward the front in the narrow space is preferably 130 mm, as one example.

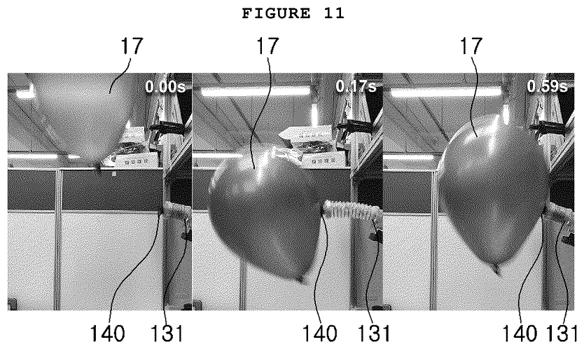

FIG. 11 is a diagram sequentially illustrating an example of capturing a moving object using the longitudinally deployable vacuum suction cup according to one embodiment of the present invention.

Referring to FIG. 11 in conjunction with FIG. 3, in one embodiment of the present invention, the longitudinally deployable vacuum suction cup (100) includes a suction cup (140) coupled to the front end of the gripper body (131), which is deployed forward. That is, the longitudinally deployable vacuum suction cup (100) according to one embodiment of the present invention can be utilized even in dynamic grasping situations for capturing moving objects, due to its rapid deployment and contraction time. This makes it suitable for use as a gripper on moving platforms, such as drones, where the relative position between the object and the gripper changes in real time.

When the vacuum state is released, the gripper body (131) is deployed forward by the elastic forces of the outer spring (133) and the inner spring (134), thereby gripping the moving object (17).

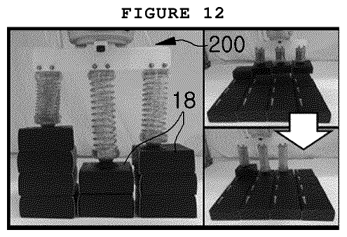

FIG. 12 is a diagram illustrating an example in which objects having different heights are simultaneously transferred using a longitudinally deployable vacuum suction cup according to another embodiment of the present invention.

Referring to FIG. 12 in conjunction with other drawings, an example is illustrated in which multiple longitudinally deployable vacuum suction cups are used to simultaneously transfer objects of varying heights.

In FIG. 12, a plurality of objects (18) having the same thickness but differing in height due to varying stacking counts are arranged in a stack.

The longitudinally deployable vacuum suction cup (200) according to another embodiment of the present invention is configured to include a plurality of gripper bodies (131).

Each of the plurality of gripper bodies (131) is connected to the vacuum pump (110) through a plurality of air hoses.

The plurality of gripper bodies (131) each grips a plurality of objects (18) having different heights, and a description of the same parts is omitted.

As shown in FIG. 12, the plurality of gripper bodies (131) of the longitudinally deployable vacuum suction cup (200) according to another embodiment of the present invention are each deployed for a plurality of objects (18) having different stacking heights, and each suction cup (140) contacts and seals with the plurality of objects (18), thereby enabling proper gripping and transfer.

As described above, in the longitudinally deployable vacuum suction cup (100) according to one embodiment of the present invention, the gripper body (131) is in the form of a hollow cylindrical shape made of an LDPE film, with a spring having elasticity embedded inside. When a negative pressure is applied by the vacuum pump (110), the gripper body (131) contracts in the longitudinal direction, and sealing is released, i.e., the vacuum is released and connected to atmospheric pressure, causing the gripper body (131) to deploy in the longitudinal direction by the restoring force of the outer and inner springs (133, 134). Since the gripper body (131) and the outer and inner springs (133, 134) are made of a flexible film, even if the target object is inclined, the gripper can adapt to the object and securely grasp it. Furthermore, since the outer and inner springs (133, 134) are not compressed in the diameter direction, they also assist in ensuring that the gripper body (131) is only compressed in the longitudinal direction.

As previously described, the pneumatic circuit design for generating a vacuum in the longitudinally deployable vacuum suction cup (100) according to one embodiment of the present invention will now be explained. Through the pneumatic circuit design, the gripper body (131) deploys toward the object without the need for control, contacts and seals with the object, and grips the object, i.e., the suction cup (140) is vacuum-adsorbed onto the object and contracts.

The gripping strategy, i.e., the pneumatic circuit design, is configured to include the picking preparation stage, the picking stage, and the arrangement stage. Throughout all stages of the picking preparation, picking, and arrangement stages, the vacuum pump continues to operate.

In the picking preparation stage, the passage of the suction cup (140) is connected to the atmosphere through the three-way valve (124), making the gripper body (131) in a contracted state under vacuum. Subsequently, when the passage of the suction cup (140) is connected to the vacuum pump (110) via the three-way valve (124), air from the atmosphere enters the gripper body (131) through the suction cup (140), releasing the vacuum in the gripper body (131). At this point, the gripper body (131) deploys in the longitudinal direction due to the restoring force of the compressed springs (133, 134). As the suction cup (140), coupled to the front of the gripper body (131), deploys, it contacts and seals with the object, and the suction cup (140) grips the object while contracting. After the object has been moved to the desired placement position, the passage of the suction cup (140) is connected to the atmosphere through the three-way valve (124), allowing the gripper body (131) to contract and the suction cup (140) to release the object. The key point here is that, in the picking stage, the deployment and contraction of the gripper body (131) and the gripping of the suction cup (140) occur without any sensing or control, enabling the easy gripping of distant or inclined objects.

Therefore, the longitudinally deployable vacuum suction cup according to the present invention can grip various objects regardless of distance or angle, can grip moving objects, and can reduce costs with a simple structure. Additionally, it is suitable for use in logistics processes where the environment is not standardized or in dynamic situations where the relative position between the object and the gripper continuously changes, thus enhancing its applicability.

Accordingly, the sensing and control costs required for gripping the suction cup in unstructured environments, where vision sensing errors are frequent, can be effectively reduced. This is particularly effective for applications in logistics processes with diverse object shapes and arrangements or in empty picking operations.

A person skilled in the art to which the present invention pertains will understand that the present invention can be embodied in other specific forms without changing its technical spirit or essential characteristics. Therefore, the embodiments described above are merely the most preferred embodiments selected for the purpose of aiding the understanding of those skilled in the art from among various possible embodiments, and the technical spirit of the invention is not limited or restricted to the embodiments presented. It is understood that various modifications, additions, and changes can be made without departing from the technical spirit of the invention, and equivalent alternative embodiments are also possible.

### INDUSTRIAL APPLICABILITY

The longitudinally deployable vacuum suction cup according to the present invention has the following effects.

First, it can grip various objects regardless of distance or position.

Second, it is capable of gripping moving objects.

Third, it can reduce costs with a simple structure.

Fourth, it can be used in logistics processes where the environment is unstructured or in dynamic situations where the relative positions of the object and the gripper continuously change, thereby enhancing its applicability.

Fifth, in unstructured environments where vision sensing errors are frequent, the need to measure the exact position of an object through vision sensing is eliminated, effectively reducing the sensing and control costs required for gripping the suction cup. This is particularly effective for applications in logistics processes with diverse object shapes and arrangements or in empty picking operations.

Sixth, according to the present invention, the gripper body can be folded when not in use, reducing the risk of collision with the surrounding environment, and it has the advantage of being able to extend up to 2.4 times its initial length.

1. A longitudinally deployable vacuum suction cup comprising;
a vacuum pump that generates a vacuum;
a plurality of air hoses connected to the vacuum pump through which air moves;
a gripper body having one end connected to the plurality of air hoses so as to be deployed;
an internal air hose located inside the gripper body through which air moves;
an outer spring located between the gripper body and the internal air hose;
a suction cup coupled to the other end of the gripper body and connected to the internal air hose to grip an object; and
a three-way valve connecting the internal air hose and the vacuum pump.

2. The longitudinally deployable vacuum suction cup of claim 1, wherein the vacuum pump is operated and the gripper body is deployed such that the suction cup grips an object.

3. The longitudinally deployable vacuum suction cup of claim 1, wherein the plurality of air hoses are respectively connected to the gripper body.

4. The longitudinally deployable vacuum suction cup of claim 1, wherein one of the plurality of air hoses is provided with a three-way valve that allows air to move to an external atmosphere.

5. The longitudinally deployable vacuum suction cup of claim 1, wherein the gripper body is made of a polymer compound.

6. The longitudinally deployable vacuum suction cup of claim 5, wherein the polymer compound is made of a transparent LDPE film, a transparent thermoplastic polyurethane elastomer (TPU), or a flexible polymer.

7. The longitudinally deployable vacuum suction cup of claim 5, wherein the material of the gripper body is made of a fabric.

8. The longitudinally deployable vacuum suction cup of claim 5, wherein the material of the gripper body has a bendable flexibility.

9. The longitudinally deployable vacuum suction cup of claim 1, wherein an inner spring is embedded inside the internal air hose.

10. The longitudinally deployable vacuum suction cup of claim 9, wherein the inner spring and the outer spring are each coil-shaped springs having elasticity.

11. The longitudinally deployable vacuum suction cup of claim 1, wherein the internal air hose has a cylindrical shape.

12. The longitudinally deployable vacuum suction cup of claim 1, wherein the internal air hose has a coil shape.

13. The longitudinally deployable vacuum suction cup of claim 1, further comprising a pump connector that connects the gripper body and the plurality of air hoses.

14. The longitudinally deployable vacuum suction cup of claim 1, further comprising a suction cup connector that connects the gripper body to the suction cup.

15. A longitudinally deployable vacuum suction cup comprising;
a vacuum pump that generates a vacuum;
a plurality of air hoses connected to the vacuum pump through which air moves;
a plurality of gripper body having one end connected to the plurality of air hoses so as to be deployed;
an internal air hose located inside each of the plurality of gripper bodies through which air moves;
an outer spring located each between the gripper body and the internal air hose;
a suction cup coupled to the other end of the gripper body and connected to the internal air hose to grip an object; and
a three-way valve connecting the internal air hose and the vacuum pump.

16. A method of controlling a longitudinally deployable vacuum suction cup according to claim 1, comprising the steps of:
Operating the vacuum pump to apply negative pressure, causing the interior of the gripper body to reach a vacuum state;
Reducing the length of the gripper body due to the negative pressure generated by the vacuum pump;
Releasing the vacuum state by connecting the gripper body to the outside through the suction cup;
Deploying the length of the gripper body by the spring;
Gripping an object by the suction cup, which is coupled to the end of the gripper body; and
Reducing the length of the gripper body, with the object gripped by the suction cup, due to the negative pressure from the vacuum pump.

17. The method of controlling the longitudinally deployable vacuum suction cup of claim 16,
wherein, in the step where the gripper body is connected to the outside through the suction cup and the vacuum state is released,
a three-way valve is installed in the air hose,
and when the three-way valve is switched, the vacuum pump continues to operate,
whereby the negative pressure in the gripper body is released through the suction cup connected to the air hose and the gripper body, allowing the vacuum state to be released.

18. The method of controlling the longitudinally deployable vacuum suction cup of claim 16,
wherein, in the step where the length of the gripper body is reduced with the object gripped by the suction cup due to the negative pressure from the vacuum pump,
the interior of the gripper body is brought to a vacuum state by the sealing between the suction cup and the object.

19. The method of controlling the longitudinally deployable vacuum suction cup of claim 16,
wherein the control method further includes, after the transfer of the object gripped by the suction cup,
a step of releasing the object by switching the three-way valve,
whereby the suction cup is connected to arrange the object.
